(19) United States
(12) Patent Application Publication
(10) Pub. No.: US 2013/0282354 A1
(43) Pub. Date: Oct. 24, 2013

(54) GENERATING LOAD SCENARIOS BASED ON REAL USER BEHAVIOR

(71) Applicants: Salman Yaniv Sayers, Petach-Tikva (IL); Yair Horovitz, Mazkeret Batya (IL); Gil Perel, Herzeliya (IL); Avi Schwartzer, Rishon LeZion (IL)

(72) Inventors: Salman Yaniv Sayers, Petach-Tikva (IL); Yair Horovitz, Mazkeret Batya (IL); Gil Perel, Herzeliya (IL); Avi Schwartzer, Rishon LeZion (IL)

(21) Appl. No.: 13/449,851

(22) Filed: Apr. 18, 2012

(51) Int. Cl. G06F 9/44

(52) U.S. Cl. 703/21

(57) ABSTRACT

A method for generating a number of load scenarios can include collecting a number of real user metrics utilizing a monitor, calculating a load behavior of the number of real user metrics utilizing a baselining technique, and generating the number of load scenarios based on the load behavior.

### BACKGROUND

Test scripts can be a set of instructions that can be executed by a processor to perform a number of tests on a computing system. The set of instructions can attempt to mimic processes of the computing system. A software manager can utilize test scripts to determine if the computing system is operating properly.

### BRIEF DESCRIPTION OF THE DRAWINGS

FIG. 1 illustrates a flow chart of an example method for generating load scenarios according to the present disclosure.

FIG. 2 illustrates a block diagram of an example system for generating load scenarios according to the present disclosure.

FIG. 3 illustrates a diagram of an example computing system according to the present disclosure.

### DETAILED DESCRIPTION

Examples of the present disclosure include methods, systems, and computer-readable and executable instructions for generating load scenarios based on real user behavior. Methods for generating load scenarios can include collecting a number of real user metrics utilizing a monitor. In addition, generating load scenarios can include calculating a load behavior of the number of real user metrics utilizing a baselining technique. Furthermore, generating load scenarios can include generating the number of load scenarios based on the load behavior.

In the following detailed description of the present disclosure, reference is made to the accompanying drawings that form a part hereof, and in which is shown by way of illustration how examples of the disclosure can be practiced. These examples are described in sufficient detail to enable those of ordinary skill in the art to practice the examples of this disclosure, and it is to be understood that other examples can be utilized and that process, electrical, and/or structural changes can be made without departing from the scope of the present disclosure.

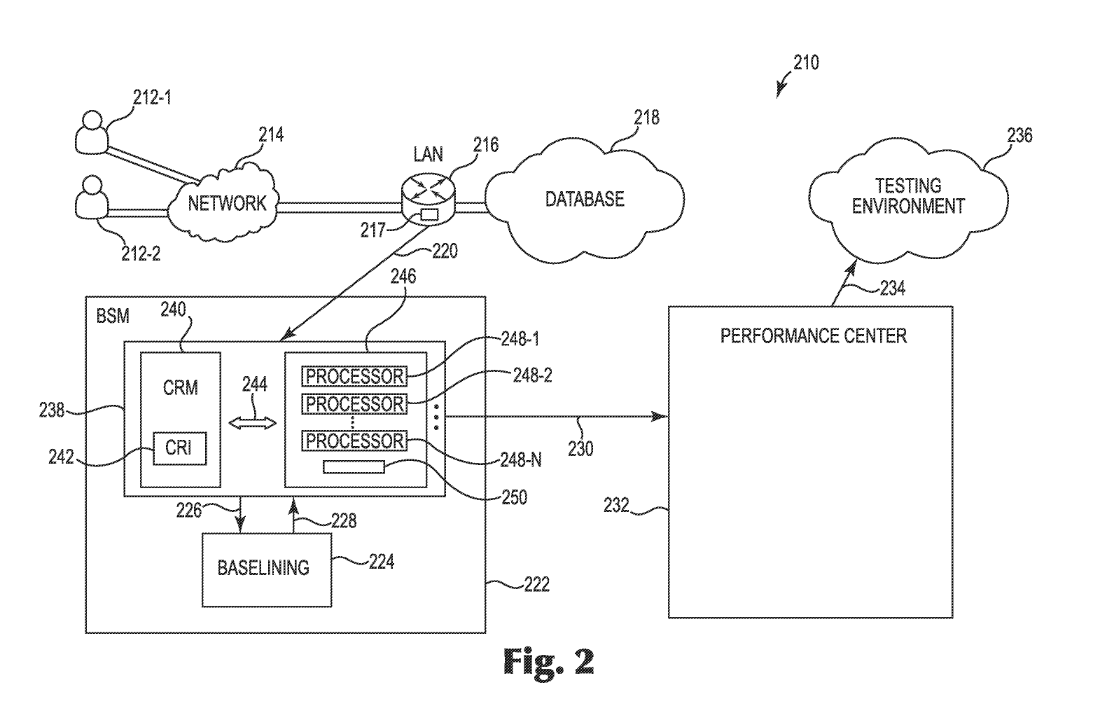

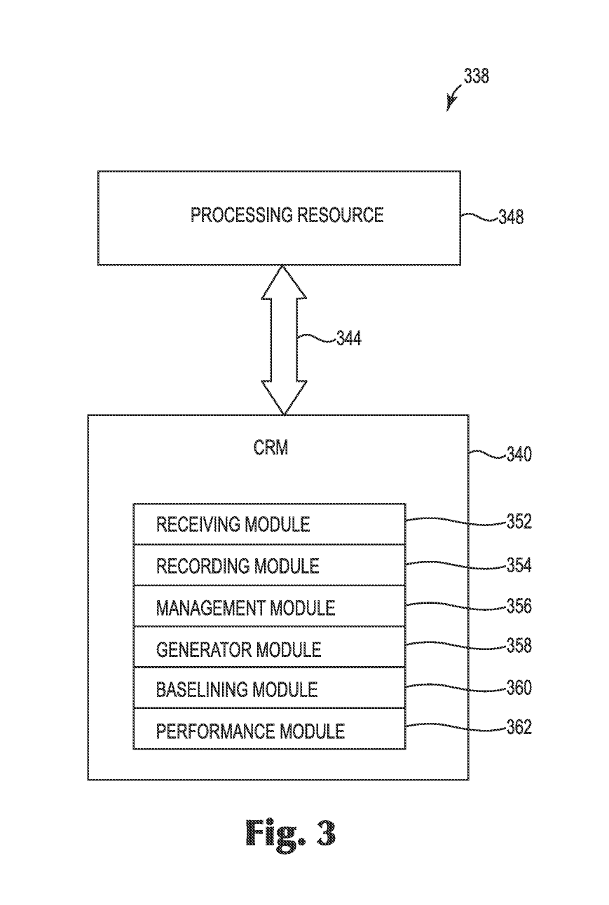

The figures herein follow a numbering convention in which the first digit or digits correspond to the drawing figure number and the remaining digits identify an element or component in the drawing. Similar elements or components between different figures may be identified by the use of similar digits. For example, 240 may reference element “40” in FIG. 2, and a similar element may be referenced as 340 in FIG. 3.

A number of test scripts for a particular application can currently be defined and/or created for an application. The number of test scripts can mimic user actions that are currently utilizing the application. For example, test scripts can create a number of transactions and/or hits for the application to process. A user can include, but is not limited to, a person, a computing device, an operator of a computing device, etc. The number of transactions and/or hits can create a load on the application and a performance can be observed and/or determined. By utilizing a monitor (e.g., real user monitor (RUM)) to collect a number of real user metrics (e.g., behaviors, pacing, think time, etc.), load test scenarios can be automatically created to better mimic real world conditions utilizing a number of new and/or existing test scripts.

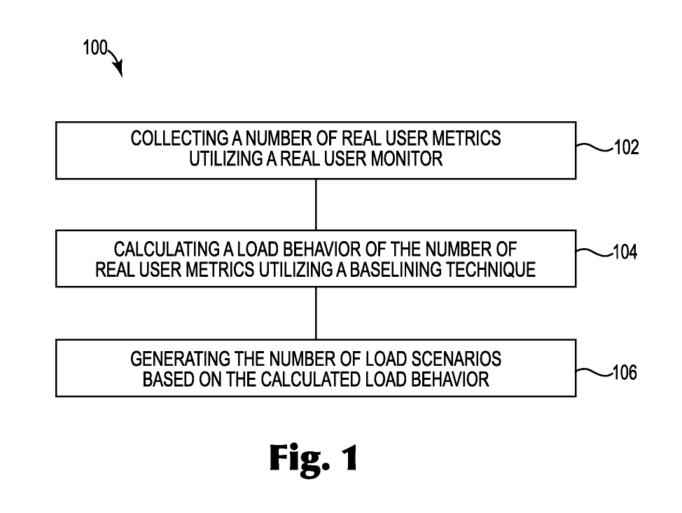

FIG. 1 illustrates a flow chart of an example method 100 for generating load scenarios according to the present disclosure. A load scenario can include a number of parameters (e.g., number of virtual users, scheduling, pacing, think time, etc.) that can be assigned to a number of test scripts for a particular application.

At 102, a number of real user metrics are collected utilizing a monitor. The monitor can be a number of network probes. The number of network probes can include hardware, software, and/or a combination of hardware and software. The monitor can passively monitor user experience across multiple tiers of an application. For example, the monitor can monitor a number of individual processes within an application. The monitor can monitor user decisions, measure response times of the user, measure response times of the application, and determine if the application is functional for the user. The application can be determined to be functional based on a number of criteria (e.g., response time, number of response for a period of time, accurate output, user preferences, etc.). For example, the application can be determined functional if the application is responding according to a set of user specifications.

The monitor can be utilized to monitor, record, and replay a real user session. For example, the monitor can record a user experience over a period of time and/or between accessing the application and leaving the application.

The monitor can generate new testing scripts for an application based on the real user sessions. For example, the monitor could record real user activity for a number of days and automatically create a number of test scripts for the application that mimic the real user activity for the real user session.

At 104 a load behavior is calculated from the real user metrics utilizing a baselining technique. In one example, a baselining technique can include generating a normalized model of the real user metrics. The normalized model can be generated by a number of techniques (e.g., eliminating outliers, eliminating unusual traffic, eliminating downtime, etc.). For example, the normalized model can be generated by eliminating any outlier data within the real user metrics.

The load behavior can be calculated using the number of real user metrics collected by the monitors. The load behavior can be an application behavior for a period of time. For example, the load behavior could represent the application behavior that occurs frequently (e.g., most frequently). The application behavior that occurs frequently can be considered a typical application behavior (e.g., average use over a period of time, median use over a period of time, actual behavior for a period of time, eliminating outlier extreme data points, etc.). The typical application behavior can be calculated utilizing a number of mathematical processes. For example, the typical application behavior can include, but is not limited to: an average, a mean, a median, and/or a standard deviation. By utilizing the real user metrics the load behavior can be a representation of real application behavior over a period of time.

The load behavior can include determining an amount of traffic for the entire application for a number of time periods. For example, the behavior of an application can change when there is a fluctuation from a greater number of users to a lesser number of users over a time period (e.g., a day, a month, a year, etc.). The amount of traffic for the application can include, but is not limited to, a number of users sending data to the application, a number of users receiving data from the application, an amount of data that is processed by the application, and/or a number of users in think time utilizing the application.

The load behavior can include determining an amount of traffic for a number of individual processes within an application to generate a process mix. For example, the application can include a number of business processes that a user can access. In this example, the load behavior can include real user metrics for each of the number of business processes. By determining an amount of traffic for a number of individual processes within an application the process mix can be determined.

The process mix can change the load behavior for the application when the traffic for the different individual processes changes. The process mix can show changes in the load behavior as the traffic for an individual process increases and/or decreases. For example, process 1 can have a load of X users at a first particular time and this load can have a first effect on the load behavior of the overall application. In this example, process 2 can have a load of Y users at a second particular time and this load can have a second effect on the load behavior of the overall application. The first effect and the second effect on the load behavior of the overall application can be different.

The process mix can be utilized to determine an average, a minimum, and/or a maximum traffic for each of the individual processes at particular times. The average, minimum, and/or maximum traffic for each of the individual processes can be used to calculate the load behavior for the application. For example, the load behavior can represent the process mix for each of the individual processes. The average traffic can be calculated utilizing a number of mathematical calculations to measure a central tendency. For example, the average traffic can be calculated utilizing a standard deviation, a mean, a median, and/or an average of the actual process mix traffic.

The different processes can be analyzed to determine a quantity of monitors and a type of monitor for each of the quantity of monitors used for the application and/or load test. For example, process 1 may require monitors of type A and process 2 may require monitors of type A and type B. The quantity and type of monitors can be automatically updated as the process mix changes. For example, the process mix can change over a period of time (e.g., hour of a day, month, year, etc.) and, as the process mix changes, the monitor types and quantity can be adjusted (e.g., add new monitors, remove existing monitors, etc.).

The process mix can be utilized to determine a frequency parameter for the number of individual processes of the application. For example, the frequency parameter can be a number of times the individual process is utilized during the period of time that the application is being monitored. The frequency parameter can be one of the number of parameters assigned to the number of test scripts by a load scenario. Assigning the frequency parameter can simulate real usage patterns of the number of individual processes.

The load behavior can include a number of real user pacing and think time metrics collected by the monitors. The number of real user pacing and think time metrics can include an amount of time that a user is utilizing an individual process. For example, the pacing and think time metrics can include the amount of time it takes a user to fill out an information form before sending the form to the application for processing.

Pacing and think time metrics can predict an amount of time between requests. For example, if an individual process is a form request, the pacing and think time information can be utilized to determine how much time a user is likely to spend filling out the form before submitting the form. The pacing and think time information can be included in the load behavior to predict the frequency of responses and/or requests in a real user environment.

At 106 a number of load scenarios are generated based on the load behavior of an application. The number of load scenarios can be a representation of the load behavior over a number of periods. For example, the monitor can be collecting a number of real user metrics for a two week period and a number of load scenarios could be generated by a load scenario generator, based on the calculated load behavior for the two week period.

The load behavior for an application can change. For example, a business application can have an original load behavior. However, as the business expands the business application can have an increased amount of traffic and the increased amount of traffic can result in a changed load behavior. In this example, the original load behavior and the changed load behavior can, for example, be stored in a business availability center (BAC) resource.

The number of load scenarios can be retrieved from the BAC resource by a performance center resource having a memory coupled to a number of processing resources and executed in a testing center having the same and/or different memory coupled to the same and/or different number of processing resources to determine a performance of the application. For example, the number of load scenarios can comprise a number of parameters that can be assigned to a number of testing scripts.

The number of parameters can be based on the calculated load behavior. For example, the number of load scenarios can include, among other parameters, a number of virtual users, a scheduling, a pacing, a quantity of data to processes, a number of transactions, and/or a think time.

The baselining technique can be used to determine a test load behavior from the performance results of the application, wherein the performance results are determined by executing the number of load scenarios. In one embodiment the test load behavior can have similar or the same testing criteria to the load behavior for the application. For example, the test load behavior can be determined from the same real user metrics as the load behavior for the application.

The test load behavior can be compared to the load behavior of the application to determine an accuracy level of the number of load scenarios. The accuracy level can be determined by how related the test load behavior is to the load behavior of the application. For example, the results of the baselining technique of the real user metrics can be the same, or nearly the same, as the results of the baselining technique for the testing environment.

The accuracy level can be used to validate the number of load scenarios. For example, the accuracy level can be used to determine if the number of load scenarios create a test load behavior that is within a predetermined threshold. Furthermore, if it is determined that the test load behavior is outside a predetermined threshold for the accuracy level (e.g., deviation), changes to the number of load scenarios can be made in order to alter the accuracy level to a test load behavior within the predetermined threshold. In one embodiment, if the accuracy level is within the predetermined threshold, the number of load test scenarios are accurately representing real user behavior in the testing environment.

FIG. 2 illustrates a diagram of a system 210 for generating a number of load scenarios according to the present disclosure. The system 210 can be utilized to generate a number of load scenarios and to execute the number of load scenarios in a testing environment 236.

The system can include a number of users 212-1, 212-2 that are obtaining data from and/or communicating with a database 218 via a network 214. A number of local area networks (LAN) 216, wide area networks (WAN), etc. can be connected to the network 214. A number of monitors 217 can be within the number of LAN 216 to monitor and/or record a number of real user metrics and/or end user experiences for the number of users 212-1, 212-2. The number of monitors 217 can send, via a network connection 220, the number of real user metrics to a business service management (BSM) module 222.

The BSM 222 can include a BAC resource 238 having a memory and processing resources within instructions (e.g., computer-readable instructions (CRI) 242) stored in the memory and executed by the processing resources to generate a number load scenarios. As described herein, the BAC resource 238 can utilize software, hardware, firmware, and/or logic to generate a number of load scenarios based on a load behavior. The BAC resource 238 can be any combination of hardware and/or program instructions (e.g, CRI) configured to generate a number of load scenarios based on the load behavior. The hardware, for example, can include one or more processing resources 248-1, 248-2, . . . , 248-N, computer readable medium (CRM) 240, etc. The program instructions can include instructions stored on the CRM 240 that are executable by the one or more processing resources to implement one or more of the various functions, or specific acts described herein (e.g., receive a number of real user metrics, generate a number of load scenarios, manage the number of load scenarios).

The BAC resource 238 can include the CRM 240 in communication with the processing resources 248-1, 248-2, . . . , 248-N. The BAC resource 238 is represented within the BSM 222. The BAC resource 238 can also be implemented outside of the BSM 222, either communicatively coupled to the BSM 222 and/or performed by a different computing device.

CRM 240 can be in communication with a computing device 246 (e.g., a Java® application server, among others) having processing resources of more or fewer than 248-1, 248-2, . . . , 248-N. The computing device 246 can be in communication with a tangible non-transitory CRM 240 storing a set of computer-readable instructions (CRI) 242 executable by one or more of the processing resources 248-1, 248-2, . . . , 248-N, as described herein. The CRI 242 can also be stored in remote memory managed by a server and represent an installation package that can be downloaded, installed, and executed. The computing device 246 can include memory resources 250, and the processing resources 248-1, 248-2, . . . , 248-N can be coupled to the memory resources 250.

Processing resources 248-1, 248-2, . . . , 248-N can execute CRI 242 that can be stored on an internal or external non-transitory CRM 240. The processing resources 248-1, 248-2, . . . , 248-N can execute CRI 242 to perform various functions, including the functions described in the method 100. For example, the processing resources 248-1, 248-2, . . . , 248-N can execute CRI 242 to generate a number of load scenarios based on the load behavior. A non-transitory CRM (e.g., CRM 240), as used herein, can include volatile and/or non-volatile memory. Volatile memory can include memory that depends upon power to store information, such as various types of dynamic random access memory (DRAM), among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The non-transitory CRM 240 can be integral, or communicatively coupled, to the computing device 246, in a wired and/or a wireless manner. For example, the non-transitory CRM 240 can be an internal memory, a portable memory, a portable disk, or a memory associated with another computing resource (e.g., enabling CRIs to be transferred and/or executed across a network such as the Internet).

The CRM 240 can be in communication with the processing resources 248-1, 248-2, . . . , 248-N via a communication path 244. The communication path 228 can be local or remote to a machine (e.g., a computer) associated with the processing resources 248-1, 248-2, . . . , 248-N. Examples of a local communication path 228 can include an electronic bus internal to a machine (e.g., a computer) where the CRM 240 is one of volatile, non-volatile, fixed, and/or removable storage medium in communication with the processing resources 248-1, 248-2, . . . , 248-N via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 228 can be such that the CRM 240 is remote from the processing resources e.g., 248-1, 248-2, 248-N, such as in a network connection between the CRM 240 and the processing resources (e.g., 248-1, 248-2, . . . , 248-N). That is, the communication path 228 can be a network connection. Examples of such a network connection can include a local area network (LAN), wide area network (WAN), personal area network (PAN), and the Internet, among others. In such examples, the CRM 240 can be associated with a first computing device and the processing resources 248-1, 248-2, . . . , 248-N can be associated with a second computing device (e.g., a Java® server, BAC resource 238). For example, a processing resource 248-1, 248-2, . . . , 248-N can be in communication with a CRM 240, wherein the CRM 240 includes a set of instructions and wherein the processing resource 248-1, 248-2, . . . , 248-N is designed to carry out the set of instructions to generate a number of load scenarios.

The processing resources 248-1, 248-2, . . . , 248-N coupled to the memory 242 can execute program instructions to enable BAC resource 238 to record a number of real user metrics received from a monitor 217. The processing resources 248-1, 248-2, . . . , 248-N coupled to the memory 242 can also execute program instructions to calculate a load behavior from the real user metrics utilizing a baselining application 224. The processing resources 248-1, 248-2, . . . , 248-N coupled to the memory 242 can also execute program instructions to generate a number of load scenarios from the load behavior utiling a load scenario generator. Furthermore, the processing resources 248-1, 248-2, . . . , 248-N coupled to the memory 242 can execute program instructions to execute the number of load scenarios in a testing environment.

The BSM 222 can include a baselining application 224. The baselining application 224 can comprise software, hardware, and/or logic, as described herein, to determine a load behavior based on the number of real user metrics. The baselining application 224 can be any combination of hardware and program instructions configured to generate the load behavior. The hardware, for example can include one or more processing resources 248-1, 248-2, . . . , 248-N, computer readable medium (CRM) 240, etc., and operate as described herein to generate the load behavior.

The baselining application 224 is represented inside the BSM 222. The baselining application 224 can also be implemented outside of the BSM 222, either communicatively coupled to the BSM 222 and/or performed by a different computing device. The baselining application 224 can also be implemented within the same computing device 246 communicatively coupled to the CRM 240 as the BAC resource 238.

The BAC resource 238 can send a number of real user metrics to the baselining application 224 via a communication path 226. The baselining application can determine a load behavior based on the number of real user metrics and respond to the BAC resource 238 via a communication path 228. The communication paths 226 and 228 can be the same type of communication path, a similar communication path, and/or a different communication path.

The BAC resource 238 can send the load behavior that was determined by the baselining application 224 to a performance center resource 232 via a communication path 230. The performance center resource 232 can execute the number of load scenarios into a testing environment 236.

The performance center resource 232 is represented outside the BSM 222 as being communicatively coupled via the communication path 230. The performance center resource 232 can also be implemented inside of the BSM 222. The performance center resource 232 can also be implemented within the same computing device 246 communicatively coupled to the CRM 240 as the BAC resource 238. The operations of the performance center resource described herein can be stored as instructions within the CRI 242 and executed by processing resources 248-1, 248-2, . . . , 248-N.

The performance center resource 232 can execute program instructions to retrieve a number of load scenarios from the BAC resource 238 and execute the number of load scenarios within the testing environment 236. The testing environment 236 can execute program instructions to apply a testing load to a real application and/or a number of simulation applications. A simulation application can be a computing device designed to simulate the responses of the real application. The performance center resource 232 can execute the number of load scenarios utilizing a communication path 234.

As used herein, “logic” is an alternative or additional processing resource to execute the actions and/or functions, etc., described herein, which includes hardware (e.g., various forms of transistor logic, application specific integrated circuits (ASICs), etc.), as opposed to computer executable instructions (e.g., software, firmware, etc.) stored in memory and executable by a processing.

FIG. 3 illustrates a diagram of an example computing system 338 according to the present disclosure. The computing system 338 can comprise a processing resource 348. The processing resource 348 can, for example, be the processing resources 248-1, 248-2, . . . , 248-N described in FIG. 2.

The processing resource 348 can be communicatively coupled to a CRM 340 via a communication path 344. The CRM 340 can be similar to CRM 240 described in FIG. 2. The CRM 340 can include a number of modules 352, 354, 356, 358, 360, 362. The number of modules can include CRI that can be executed, for example, by the processing resource 348, to perform a number of functions.

A receiving module 352 can, for example, include a number of CRI executable by a number of processing resources to perform or achieve the particular act or carry out the act of receiving a number of real user metrics from the monitors (e.g., RUM 217).

A recording module 354 can include a number of instructions that can be executed by the processing resource 348. For example, the recording module can write to memory and/or record the number of real user metrics.

A management module 356 can comprise a number of instructions that can be executed by the processing resource 348. For example, the management module 356 can organize the number of real user metrics. The management module can store real user metrics to be sent to the baselining module 360. For example, the management module can be executed automatically at a particular time and store a number of real user metrics for a specific time period (e.g., a day, a year, an hour, etc.).

The management module 356 can also comprise an end user management application that can compare a baseline of the number of real user metrics and a production baseline. The production baseline can be a baseline of user metrics for a particular computing system. The production baseline can be determined at the time of production for the particular computing system. By comparing the baseline of the number of real user metrics and the production baseline, a number of load scenarios can be adjusted to execute a desired load behavior.

The baselining module 360 can include aspects and function of the baselining application 224 from FIG. 2 as described herein. The baselining module can execute instructions to perform a number of baselining techniques. The baselining module 360 can format the real user metrics to a desired file format. For example, if the baselining module 360 requires a specific format that is different than the current format of the real user metrics, the management module 356 can format the real user metrics to the specific format. The baselining module 360 can calculate a number of load behaviors for the application based on the number of real user metrics, as described herein.

The management module 356 can receive a number load behaviors from the baselining module 360 and organize the number of load behaviors that can be retrieved by a generator module 358.

The generator module 358 can include a number of instructions that can be executed by the processing resource 348. For example, the generator module can retrieve a number of load behaviors from the management module 356 and generate a number of load scenarios based on the load behaviors. The generator module can be the load scenario generator as described herein. The generator module 358 can automatically update tests scripts as changes occur in the load behavior. For example, the generator module 358 can determine the most recent load behavior within the management module 356 and utilize the most recent load behavior.

A performance module 362 can include a number of instructions that can be executed by the processing resource 348. For example, the performance module 362 can retrieve the number of load scenarios from the generator module 358 and/or the management module 356 and execute the number of load scenarios into a testing environment (e.g., a real application and/or simulated application, the testing environment 236 shown in FIG. 2). The performance module 362 can utilize the load scenarios to assign a number of parameters (e.g., number of virtual users, scheduling, pacing, think time, etc.) to a number of existing test scripts. The number of parameters can be utilized to operate the number of existing test scripts in the testing environment.

The specification examples provide a description of the applications and use of the system and method of the present disclosure. Since many examples can be made without departing from the spirit and scope of the system and method of the present disclosure, this specification sets forth some of the many possible example configurations and implementations.

What is claimed:

1. A method for generating a number of load scenarios, comprising:
collecting a number of real user metrics utilizing a monitor;
calculating a load behavior of the number of real user metrics utilizing a baselining technique; and
generating the number of load scenarios based on the calculated load behavior.

2. The method of claim 1, wherein collecting real user metrics comprises determining a load for a number of individual processes and a process mix of the individual processes.

3. The method of claim 1, wherein calculating a load behavior utilizing a baselining technique comprises determining an average traffic for a process mix of an application.

4. The method of claim 1, further comprising utilizing a process mix to determine a frequency parameter for the number of load scenarios.

5. The method of claim 1, wherein collecting a number of real user metrics comprises monitoring a number of individual processes and determining a quantity of monitors and a type for each of the quantity of monitors.

6. The method of claim 1, further comprising determining a number of individual processes within an application to monitor based on the number of real user metrics.

7. A non-transitory computer-readable medium storing a set of instructions executable by a processor to cause a computer to:
receive, from a monitor, a number of real user metrics for a determined number of processes within an application;
calculate a load behavior for the number of processes based on the number of real user metrics; and
generate a load scenario for the application based on the load behavior for the number of processes.

8. The medium of claim 7, wherein the number of real user metrics comprises pacing and think time information for the number of processes within an application.

9. The medium of claim 7, further comprising to store a set of instructions to cause the computer to present an accuracy level to a user for validation of the load scenario.

10. The medium of claim 9, wherein validation of the load scenario comprises altering the load scenario to generate a desired test load behavior.

11. The medium of claim 7, further comprising to store a set of instructions to cause the computer to assign parameters to a number of scripts based on the load scenario.

12. A system for generating load scenarios, the system comprising:
a processing resource in communication with a non-transitory computer readable medium, wherein the non-transitory computer readable medium includes a set of instructions and wherein the processing resource executes the set of instructions to:
receive a number of real user metrics received from a monitor;
calculate a load behavior from the real user metrics utilizing a baselining module;
generate a number of load scenarios from the load behavior utilizing a load scenario generator; and
execute the number of load scenarios to apply a testing load to a number of real or simulated applications on a network or in a testing environment.

13. The system of claim 12, further comprising an end user management application to compare a baseline of the number of real user metrics to a production baseline to adjust the number of load scenarios.

14. The system of claim 12, wherein the load scenario generator executes instructions to automatically update current test scripts as changes occur in the calculated load behavior.

15. The system of claim 12, further comprising instructions that are executed to update a quantity and a type of monitors as a process mix changes.
